(19) United States
(12) Patent Application Publication
(10) Pub. No.: US 2024/0250302 A1
(43) Pub. Date: Jul. 25, 2024

(54) HAIRY NANOPARTICLE COMPOSITIONS FOR USE AS ADDITIVES IN BATTERY ELECTROLYTES

(71) Applicant: UT-Battelle, LLC, Oak Ridge, TN (US)

(72) Inventors: Vera Bocharova, Knoxville, TN (US); Seung Pyo Jeong, Dublin, CA (US); Xi Chen, Knoxville, TN (US); Andrew S. Westover, Knoxville, TN (US)

(21) Appl. No.: 18/378,373

(22) Filed: Oct. 10, 2023

Related U.S. Application Data
(60) Provisional application No. 63/414,621, filed on Oct. 10, 2022.

(51) Int. Cl. H01M 10/0567; H01M 10/0562; H01M 10/0565

(52) U.S. Cl. CPC H01M 10/0567; H01M 10/0562; H01M 10/0565

(57) ABSTRACT

A hairy nanoparticle (HNP) composition comprising: (i) a nanoparticle core; and (ii) an ion-conductive polymer chemically attached to the nanoparticle core, wherein the ion-conductive polymer is either polyanionic with mobile cations or polycationic with mobile anions. Also described herein is a method for producing the HNP composition, electrolytes containing the HNP composition incorporated therein, and batteries (e.g., metal and metal-ion, such as lithium ion batteries) containing electrolytes (e.g., solid, gel, or liquid) in which the HNP composition has been incorporated.

### CROSS REFERENCE TO RELATED APPLICATION

The present application claims benefit of U.S. Provisional Application No. 63/414,621, filed on Oct. 10, 2022, all of the contents of which are incorporated herein by reference.

### GOVERNMENT SUPPORT

This invention was made with government support under Prime Contract No. DE-AC05-00OR22725 awarded by the U.S. Department of Energy. The government has certain rights in the invention.

### FIELD OF THE INVENTION

The present invention generally relates to electrolyte compositions for metal-ion batteries, such as lithium-based batteries. The present invention more particularly relates to nanoparticle compositions that can be used in electrolytes of metal-ion batteries. The present invention further relates to compositions (e.g., additives) for electrolytes and methods useful in preventing dendrite formation in metal-ion batteries.

### BACKGROUND

For several decades, solid-state batteries have been a subject of extensive research and development due to the benefits they offer in terms of safety and high energy density. Advancement in solid-state batteries will require improvements in solid electrolyte design and processing. Currently developed solid electrolytes, with few exceptions, are prone to dendrite formation that result in battery cells shortening. Through developed theoretical models and experimental observations, several factors have been identified that are capable of inhibiting dendrite growth. According to the Monroe and Newman theoretical model, dendrite growth can be suppressed if the shear modulus of the solid electrolyte is two-fold larger than that of Li (4.8 GPa at 298 K). Moderate improvements in mechanical modulus have been made by adding fibers and nanoparticles, yet dendrites still form in various composites, conductive ceramics, and polymer electrolytes, even those with mechanical properties as high as 12 GPa. These findings suggest that improved mechanical properties are not alone sufficient to completely prevent dendrites. Another factor that contributes to formation of dendrites is heterogeneous Li charge distribution initiated during electrochemical cycling. An increase in the Li-ion transport number is believed to alleviate, and possibly eliminate (for single-ion-conductors) concentration gradients in the bulk electrolyte, thereby precluding dendrite formation.

Solid electrolytes, such as single-ion conducting ceramics and polymerized ionic liquids, provide an improved battery performance by combining high mechanical strength and high Li-transport number. However, their use as material electrolyte is associated with a number of challenges. In particular, since single-ion conducting ceramics are brittle, they are difficult to pack, and when their packing is disturbed, dendrites can still form during cycling. In the case of polymerized ionic liquids, the improved cycling performance comes at the expense of a relatively low ionic conductivity.

### SUMMARY

The present disclosure is foremost directed to nanoparticle compositions based on single ion conducting polymers that can be incorporated into any of the known battery electrolytes as additives for preventing dendrite formation. The nanoparticle compositions can advantageously achieve the prevention of dendrite formation in a number of diverse types of electrolytes (e.g., solid, gel, or liquid) while maintaining a relatively high ionic conductivity.

The nanoparticle additive is more particularly a hairy nanoparticle (HNP) composition containing the following components: (i) a nanoparticle core; and (ii) an ion-conductive polymer chemically attached to the nanoparticle core. The ion-conductive polymer may be either polyanionic with mobile cations or polycationic with mobile anions. In the case where the ion-conductive polymer is polyanionic with mobile cations, the mobile cations may be one or more of, for example, lithium, sodium, potassium, zinc, magnesium, calcium, and aluminum. In the case where the ion-conductive polymer is polycationic with mobile anions, the mobile anions may be one or more of, for example, hydroxide, halide, bisulfate, perchlorate, hexafluorophosphate, and bis(fluorosulfonyl)imides. In particular embodiments, the nanoparticle core has an inorganic composition, or more particularly, an oxide composition, e.g., silica, titania, zirconia, yttria, hafnia, niobia, or a combination of two or more of these.

In another aspect, the present disclosure is directed to electrolyte compositions in which the HNP additive is incorporated. The electrolyte medium may be a solid, gel, or liquid electrolyte medium. The solid or gel electrolyte medium may be selected from, for example, polyethylene oxide (PEO), polyvinylidene fluoride (PVDF), polymethyl methacrylate (PMMA), and polyacrylonitrile (PAN). The electrolyte medium may, in some embodiments, contain a lithium-containing salt, such as a bis(perfluoroalkylsulfonyl)imide salt. The liquid electrolyte medium typically contains a polar solvent, e.g., propylene carbonate, ethylene carbonate, or ionic liquid.

In another aspect, the present disclosure is directed to metal or metal-ion batteries containing the above-described electrolyte composition containing the HNP additive incorporated therein. The metal or metal-ion battery includes: a) an anode; (b) a cathode; and (c) an electrolyte composition as described above. The electrolyte medium may be a solid, gel, or liquid electrolyte medium or any of the specific compositions described above. In some embodiments, the metal-ion battery is more particularly an alkali-ion battery, such as a lithium-ion or sodium-ion battery.

### BRIEF DESCRIPTION OF THE DRAWINGS

FIG. 1. Scheme (top portion) showing exemplary synthesis of silica NPs functionalized with a RAFT-initiator, herein denoted as CTA-silica NPs, followed by grafting of polyanion of poly(trifluoromethane)sulfonimide lithium methacrylate (polyMTFSILi) to form hairy silica NPs (Hairy NP) by silica surface-initiated RAFT polymerization. The polyanion is also denoted as polymerized ionic liquid (PolyIL). Scheme (bottom portion) showing exemplary synthesis of bulk polyMTFSILi polyanion by free radical polymerization using azobisisobutyronitrile (AIBN) as an initiator. The structure of RAFT-NHS is shown at the very bottom.

FIGS. 2A-2C. FIG. 2A shows 1D SAXS patterns of composites. The lines are fits to the SAXS curves using the combined lamellar, Guinier-Porod and power-law models. FIG. 2B is a table with lamellar dimensions obtained from the fitting of SAXS data. FIG. 2C is a transmission electron microscope (TEM) image of a composite containing 9.1 wt % of Hairy NP (Hairy_10).

FIGS. 3A-3C. Data presented for PolyIL PCs and PEO-LiTFSI wherein: FIG. 3A is a plot of DSC heating cycles; FIG. 3B is a plot of rheology measurements at 60° C.; and FIG. 3C is a plot of ionic conductivity vs inverse of temperature.

FIGS. 4A-4C. Data presented for Hairy PCs and PEO-LiTFSI, wherein: FIG. 4A is a plot of DSC heating cycles; FIG. 4B is a plot of rheology measurements at 60° C.; and FIG. 4C is a plot of ionic conductivity vs inverse of temperature.

FIGS. 5A-5B. FIG. 5A is a plot of the overpotential as a function of time for PolyIL PCs and PEO-LiTFSI cycled at 0.035 (area 1), 0.088 (area 2), 0.175 (area 3), and 0.35 (area 4) mA·cm⁻² at 60° C. B. FIG. 5B is a bar chart summarizing values for conductivity, mechanical stiffness, and transport number for PolyIL PCs at 60° C.

FIGS. 6A-6B. FIG. 6A is a plot of the overpotential as a function of time for Hairy PCs and PEO-LiTFSI cycled at 0.2 mA·cm⁻² at 60° C. FIG. 6B is a bar chart summarizing values for conductivity, mechanical stiffness, and transport number for Hairy PCs at 60° C.

### DETAILED DESCRIPTION

In one aspect, the present disclosure is directed to a hairy nanoparticle (HNP) composition containing at least or exclusively the following components: (i) a nanoparticle core, and (ii) an ion-conductive polymer chemically attached to the nanoparticle core. In some embodiments, the ion-conductive polymer has a backbone extending radially from the surface of the nanoparticle core. The term “nanoparticle,” as used herein, refers to a particle (i.e., nanoparticle core) having all three of its dimensions no more than 500 nm in length. In some embodiments, the three dimensions of the nanoparticle are all precisely or approximately the same, as in a spherical nanoparticle, or two or three of the dimensions are different, as in plate-shaped or elongated nanoparticles. In different embodiments, the nanoparticle core has its three dimensional lengths independently selected from 5, 10, 12, 15, 18, 20, 25, 30, 35, 40, 50, 100, 150, 200, 250, 300, 400, or 500 nm, or its dimensional lengths are independently within a range bounded by any two of the foregoing values, e.g., 5-500 nm, 10-500 nm, 5-200 nm, 10-200 nm, 5-100 nm, 10-100 nm, 5-50 nm, 10-50 nm, 5-20 nm, 10-20 nm, or 10-15 nm. When all of the dimensional lengths are the same, any of the foregoing lengths can be considered the “size” of the nanoparticle. Thus, the nanoparticles can have a size corresponding to any of the values above or within any range thereof.

The nanoparticle core can have any solid composition on which an ion-conductive polymer can be chemically (typically, covalently) attached. In a first set of embodiments, the nanoparticle core has an inorganic composition, which may be, for example, an oxide composition. Some examples of oxide compositions include silica, alumina, titania, zirconia, yttria, hafnia, niobia, and combinations (e.g., mixtures or core-shell arrangements) thereof. The oxide composition may alternatively be, for example, an iron oxide, cobalt oxide, nickel oxide, zinc oxide, tin oxide, and combinations (e.g., mixtures or core-shell arrangements) thereof. The inorganic composition may, in some embodiments, be other than an oxide composition, such as a sulfide, nitride, carbide, boride, silicide, or elemental (e.g., carbon, silicon, or noble metal) composition. In a second set of embodiments, the nanoparticle core has an organic composition, which is typically an organic polymer composition. Some examples of organic polymer compositions that can be in nanoparticle form include, for example, polyacrylate, polymethacrylate, polymethylmethacrylate, polyesters (e.g., PET, PLA, PLGA, and PCL), polysiloxanes, polyurethanes, polyalkylene oxides (e.g., PEO or PPO), polycarbonates, and amine-functionalized polymers (e.g., chitosan and polyethyleneimine). In some embodiments, the nanoparticles have a core-shell structure, wherein the core and shell may be independently selected from any of the inorganic or organic compositions described above (e.g., an inorganic/inorganic core-shell, inorganic/organic core-shell, organic/inorganic core-shell, or organic/organic core-shell structure). The core may be ionically or electronically conductive. The nanoparticle core may also be non-porous or porous. The composition of the porous nanoparticle may be, in some embodiments, a metal-organic framework (MOF) or covalent organic framework (COF) type of composition, both of which are well known in the art. In some embodiments, any one or more of the above types of nanoparticle core compositions is/are excluded form the HNP composition.

In one set of embodiments, the ion-conductive polymer is polyanionic with mobile cations. The mobile cations are typically metal cations useful in batteries, e.g., lithium, sodium, potassium, zinc, magnesium, calcium, or aluminum cations. The mobile cation should be suitable for the type of battery the HNP composition is being incorporated into (e.g., mobile lithium ions for a lithium-ion battery). The polyanionic polymer contains a multiplicity of anionic moieties, either as pendant groups or within the backbone. Some examples of anionic moieties include, for example, bis(fluorosulfonyl)imide (e.g., bis(trifluoromethane)sulfonimide), carboxylate, sulfonate, and borate moieties. The borate-containing polyanionic polymer typically contains tetracoordinated boron, such as tetraphenylborate or bis(oxaloto)borate. Polyanionic ion-conductive polymers, including those mentioned above, are well known in the art, such as described in J. Gao et al., Chem. Sci., 12, 13248 (2021), the contents of which are herein incorporated by reference.

In another set of embodiments, the ion-conductive polymer is polycationic with mobile anions. The mobile anions may be one or more of, for example, hydroxide, halide (e.g., F⁻ or Cl⁻), bisulfate, perchlorate, hexafluorophosphate, and bis(fluorosulfonyl)imides. The polycationic polymer contains a multiplicity of cationic moieties, either as pendant groups or within the backbone. The cationic moieties typically contain a positively charged nitrogen, phosphorus, or sulfur atom. Some examples of cationic moieties include, for example, imidazolium, triazolium, pyrrolidinium, pyridinium, sulfonium, phosphonium, and ammonium moieties.

In another aspect, the present disclosure is directed to an electrolyte composition containing a HNP composition, such as any of the HNP compositions described above, incorporated into an ionically conductive electrolyte medium. The electrolyte medium may be any of the electrolyte mediums known in the art to be useful in metal-ion batteries. The electrolyte medium may be a solid, gel, or liquid electrolyte medium.

In a first set of embodiments, the electrolyte medium is a solid or gel electrolyte. The solid or gel electrolyte may or may not contain a level of porosity (i.e., may or may not be porous). In the case of a porous electrolyte, the electrolyte may be microporous and may or may not also be mesoporous and/or macroporous, or the electrolyte may be mesoporous and may or may not be microporous and/or macroporous. The solid or gel electrolyte can have any of the numerous compositions well known in the art, including any of the organic or inorganic compositions known in the art, which may or may not contain ionic groups and may or may not be porous (or more specifically, microporous, mesoporous, and/or macroporous). The solid or gel electrolyte may also be crosslinked or uncrosslinked. Some examples of organic solid or gel electrolyte compositions include the polyalkyleneoxides (e.g., polyethylene oxide or polypropylene oxide, i.e., PEO or PPO, respectively), vinyl-addition polymer (e.g., PMA, PMMA, PEGDMA), fluorinated polymer (e.g., polyvinylidene fluoride, or PVDF), polyacrylonitrile (PAN), polyester, polyurethane, polycarbonate, polynitrile, polyol, polyamine, polysiloxane, and polyimide. Some examples of inorganic solid or gel electrolytes compositions include the lithium lanthanum titanates, Al-doped lithium lanthanum zirconium oxides, Ta-doped lithium lanthanum zirconates, lithium aluminum titanium phosphates, lithium tin phosphorus sulfides, and lithium phosphorus sulfur chlorides. The solid electrolyte may alternatively be a polymer-ceramic composite.

In a second set of embodiments, the electrolyte medium is a liquid electrolyte medium. Typically, the liquid electrolyte medium is or includes a polar solvent, which may or may not be an ionic liquid. Some classes of non-ionic polar solvents useful as liquid electrolyte mediums in batteries include carbonate (cyclic and acyclic), ether (cyclic or acyclic), alcohol, sulfoxide, amide (or lactam), ester (or lactone), and silicon-containing (e.g., silane and siloxane) solvents. Some examples of carbonate solvents include dimethyl carbonate (DMC), ethyl methyl carbonate (EMC), diethyl carbonate (DEC), ethylene carbonate (EC), and propylene carbonate (PC). Some examples of ether solvents include diglyme (bis(2-methoxyethyl) ether), triglyme (triethylene glycol dimethyl ether), tetraglyme (tetraethylene glycol dimethyl ether), ethylene glycol monomethyl ether, and propylene glycol methyl ether acetate (PGMEA). Some examples of alcohol solvents include ethylene glycol, propylene glycol, diethylene glycol, triethylene glycol, tetraethylene glycol, pentaethylene glycol, hexaethylene glycol, and glycerol. Some examples of sulfoxide solvents include dimethyl sulfoxide, ethyl methyl sulfoxide, diethyl sulfoxide, methyl propyl sulfoxide, and ethyl propyl sulfoxide. Some examples of sulfone solvents include methyl isopropyl sulfone (MiPS), propyl sulfone, butyl sulfone, tetramethylene sulfone (sulfolane), methyl phenyl sulfone, and phenyl vinyl sulfone. Some examples of amide solvents include N,N-dimethylformamide, N,N-diethylformamide, acetamide, dimethylacetamide, diethylacetamide, gamma-butyrolactam, and N-methylpyrrolidone. Some examples of ester solvents include n-butyl acetate, n-propyl propionate, n-butyl propionate, ethyl butyrate, n-propyl butyrate, and gamma-butyrolactone. Some examples of silicon-containing solvents include octamethyltrisiloxane, {2-[2-(2-methoxyethoxy)ethoxy]ethoxy}trimethylsilane, bis {2-[2-(2-methoxyethoxy)ethoxy]ethoxy}dimethylsilane, and dimethylsiloxane-ethylene oxide block/graft copolymers. In yet other embodiments, the polar solvent may be hexamethylphosphoramide (HMPA), 1,3-dimethyl-3,4,5,6-tetrahydro-2(1H)-pyrimidinone (DMPU), acetylacetone, or 1,3-diaminopropane. The solvent may alternatively be any one of the ionic liquids well known in the art for use in batteries, such as an imidazolium-based or piperidinium-based ionic liquid. In some embodiments, any one or more classes or specific types of polar solvents provided above are excluded from the electrolyte.

The solid, gel, or liquid electrolyte may, in some embodiments, include a metal salt appropriate for the battery in which the electrolyte is housed. The metal ion in the metal salt may be, for example, one or more of lithium, sodium, potassium, magnesium, calcium, zinc, and aluminum. The counteranion of the metal salt may be essentially any anion, and may be inorganic or organic. Some examples of inorganic counteranions include the halides (e.g., chloride, bromide, or iodide), hexafluorophosphate (PF₆⁻), hexachlorophosphate (PCl₆⁻), perchlorate, chlorate, chlorite, perbromate, bromate, bromite, iodate, aluminum fluorides (e.g., AlF₄⁻), aluminum chlorides (e.g., Al₂Cl₇⁻ and AlCl₄⁻), aluminum bromides (e.g., AlBr₄⁻), nitrate, nitrite, sulfate, sulfite, phosphate, phosphite, arsenate, hexafluoroarsenate (AsF₆⁻), antimonate, hexafluoroantimonate (SbF₆⁻), selenate, tellurate, tungstate, molybdate, chromate, silicate, the borates (e.g., borate, diborate, triborate, tetraborate), tetrafluoroborate, anionic borane clusters (e.g., B₁₀H₁₀²⁻ and B₁₂H₁₂²⁻), perrhenate, permanganate, ruthenate, perruthenate, and the polyoxometallates. Some examples of organic counteranions include the bis(perfluoroalkylsulfonyl)imides (e.g., (CF₃SO₂)₂N)⁻, fluorosulfonates (e.g., CF₃SO₃⁻, CF₃CF₂SO₃⁻, CF₃(CF₂)₂SO₃⁻, CHF₂CF₂SO₃⁻, and the like), carboxylates (e.g., formate, acetate, propionate, butyrate, valerate, lactate, pyruvate, oxalate, malonate, glutarate, adipate, decanoate, and the like), sulfonates (e.g., CH₃SO₃⁻, CH₃CH₂SO₃⁻, CH₃(CH₂)₂SO₃⁻, benzenesulfonate, toluenesulfonate, dodecylbenzenesulfonate, and the like), organoborates (e.g., BR₁R₂R₃R₄⁻, wherein R₁, R₂, R₃, R₄ are typically hydrocarbon groups containing 1 to 6 carbon atoms), dicyanamide (i.e., N(CN)₂⁻), tricyanomethanide (i.e., C(CN)₃⁻) and the phosphinates (e.g., bis-(2,4,4-trimethylpentyl)-phosphinate). In some embodiments, any one or more classes or specific types of counteranions, as provided above, are excluded from the electrolyte.

In another aspect, the present disclosure is directed to methods for producing the hairy nanoparticle (HNP) compositions described above. Methods of producing HNPs are well known and include the “grafting from,” “grafting to,” and “grafting through” methods and their combination. As well known, the “grafting from” process involves first attaching an initiator functional group (e.g., a RAFT initiator) onto the surface of the nanoparticle followed by surface-initiated polymerization (e.g., RAFT polymerization) of monomers of interest to result in growth of the polymer from the nanoparticle surface, where RAFT=reversible addition fragmentation chain transfer. As also well known, the “grafting to” process involves chemically linking (grafting) polymer molecules (polymerized chains) onto the nanoparticle surface. An advantage of the “grafting to” process is its ability to provide a high level of monodispersity, although with a lower level of grafting density than the “grafting from” process. An advantage of the “grafting from” process is its ability to provide a higher grafting density, compared to the “grafting to” process where the polymer chain is directly attached. For purposes of the present invention, the monomer should contain an ion-conductive (e.g., polyanionic or polycationic) component. Any such method can be used to produce the HNPs described herein, except with the modification that the polymer being grown or attached to the surface of the nanoparticle is an ion-conductive polymer, as described above. The various methods for producing HNPs are discussed in detail in A. Sharma et al., Front. Phys., Dec. 6, 2022, DOI:10.3389/fphy.2022.1041903, the contents of which are herein incorporated by reference.

Notably, any of the HNP compositions described earlier above, whether polyanionic or polycationic, may be incorporated into a solid, gel, or liquid electrolyte of any type of battery. The battery may be a metal-ion battery (which may employ mobile cations or a combination of mobile cations and mobile anions) or an anion-shuttle battery (i.e., ASB, which employs mobile anions). Anion-shuttle batteries are described in, for example, Q. Liu et al., Chem, 7(8), 1993-2021 (2021), the contents of which are herein incorporated by reference.

In another aspect, the present disclosure is directed to metal-ion batteries containing an electrolyte in which any of the above described HNP compositions is incorporated as an additive. The metal-ion battery contains at least an anode, a cathode, and the electrolyte in contact with or as part of the anode and/or cathode. The electrolyte may be a solid, gel, or liquid in the battery. In some embodiments, the electrolyte is solid or gel and is incorporated in the battery in the form of particles, typically as a film or membrane containing particles. In other embodiments, the solid electrolyte is incorporated in the battery in the form of a continuous film or membrane. The HNP additive can be incorporated into the electrolyte by means well known in the art. For liquid electrolytes, the additive can be mixed into the electrolyte by well known means. For solid and gel electrolytes, the additive may be mixed into a liquid precursor of the electrolyte before the electrolyte is solidified or gelled, e.g., by crosslinking or curing.

In some embodiments, the battery is a lithium-based battery. The lithium-based battery may be a lithium metal (plate) battery, in which the anode contains a film of lithium metal, or a lithium-ion battery, in which the anode contains lithium ions stored in a base material (e.g., graphite). Whether the battery contains a lithium anode or lithium-ion anode, the battery may be a single-use (primary) or rechargeable (secondary) battery.

In particular embodiments, the battery is a lithium-based single use or rechargeable battery and contains any of the electrolyte compositions known in the art, with the HNP composition incorporated therein. The electrolyte is in contact with at least one of the anode (negative electrode) and cathode (positive electrode) of the lithium metal or lithium-ion battery. Alternatively, a solid or gel electrolyte composition can be incorporated into a cathode of the battery (typically admixed with a binder material), and the anode and cathode may be in contact with the solid or gel electrolyte composition or any of the conventional liquid (e.g., polar solvent or aqueous) or solid electrolytes known in the art. The lithium metal battery may contain any of the components typically found in a lithium metal battery, such as described in, for example, X. Zhang et al., Chem. Soc. Rev., 49, 3040-3071, 2020; P. Shi et al., Adv. Mater. Technol., 5(1), 1900806 (1-15), January 2020; and X.-B. Cheng et al., Chem. Rev., 117, 15, 10403-10473 (2017), the contents of which are incorporated herein by reference. In some embodiments, the lithium metal battery contains molybdenum disulfide in the cathode. The lithium-ion battery may contain any of the components typically found in a lithium-ion battery, including positive (cathode) and negative (anode) electrodes, current collecting plates, a battery shell, such as described in, for example, U.S. Pat. No. 8,252,438, 7,205,073, and 7,425,388, the contents of which are incorporated herein by reference in their entirety. The lithium-ion battery may more specifically be a lithium-sulfur battery, as well known in the art, e.g., L. Wang et al., Energy Environ. Sci., 8, 1551-1558, 2015, the contents of which are herein incorporated by reference. In some embodiments, any one or more of the above noted components may be excluded from the battery.

In embodiments where the electrolyte is in contact with an anode and cathode of the lithium-based battery but not incorporated into the cathode, the positive (cathode) electrode can have any of the compositions well known in the art, such as, a lithium metal oxide, wherein the metal is typically a transition metal, such as Co, Fe, Ni, or Mn, or combination thereof, or manganese dioxide (MnO₂), iron disulfide (FeS₂), or copper oxide (CuO). In some embodiments, the cathode has a composition containing lithium, nickel, and oxide. In further embodiments, the cathode has a composition containing lithium, nickel, manganese, and oxide, or the cathode has a composition containing lithium, nickel, cobalt, and oxide. Some examples of cathode materials include LiCoO₂, LiMn₂O₄, LiNiCoO₂, LiMnO₂, LiFePO₄, LiNiCoAlO₂, and LiNiₓMn₂₋ₓO₄ compositions, such as LiNi_{0.5}Mn_{1.5}O₄, the latter of which are particularly suitable as 5.0V cathode materials, wherein x is a number greater than 0 and less than 2. In some embodiments, one or more additional elements may substitute a portion of the Ni or Mn. In some embodiments, one or more additional elements may substitute a portion of the Ni or Mn, as in LiNiₓCo₁₋ₓPO₄, and LiCuₓMn₂₋ₓO₄, materials (Cresce, A. V., et al., Journal of the Electrochemical Society, 2011, 158, A337-A342). In further specific embodiments, the cathode has a composition containing lithium, nickel, manganese, cobalt, and oxide, such as LiNiMnCoO₂ or a LiNi_{w-y-z}Mn_{y}Co₂O₂ composition (wherein w+y+z=1), e.g., LiNi_{0.8}Mn_{0.1}Co_{0.1}O₂. The cathode may alternatively have a layered-spinel integrated Li[Ni_{1/3}Mn_{2/3}]O₂ composition, as described in, for example, Nayak et al., Chem. Mater., 2015, 27 (7), pp. 2600-2611. To improve conductivity at the cathode, conductive carbon material (e.g., carbon black, carbon fiber, or graphite) is typically admixed with the positive electrode material. In some embodiments, any one or more of the above types of positive electrodes may be excluded from the battery.

In the lithium-based battery, the negative (anode) electrode may be lithium metal or a material in which lithium ions are contained and can flow. For lithium-ion batteries, the anode may be any of the carbon-containing and/or silicon-containing anode materials well known in the art of lithium-ion batteries. In some embodiments, the anode is a carbon-based composition in which lithium ions can intercalate or embed, such as elemental carbon, such as graphite (e.g., natural or artificial graphite), petroleum coke, carbon fiber (e.g., mesocarbon fibers), carbon (e.g., mesocarbon) microbeads, fullerenes (e.g., carbon nanotubes, i.e., CNTs), and graphene. The carbon-based anode is typically at least 70 80, 90, or 95 wt % elemental carbon. The silicon-containing composition, which may be used in the absence or presence of a carbon-containing composition in the anode, can be any of the silicon-containing compositions known in the art for use in lithium-ion batteries. Lithium-ion batteries containing a silicon-containing anode may alternatively be referred to as lithium-silicon batteries. The silicon-containing composition may be, for example, in the form of a silicon-carbon (e.g., silicon-graphite, silicon-carbon black, silicon-CNT, or silicon-graphene) composite, silicon microparticles, or silicon nanoparticles, including silicon nanowires. The negative electrode may alternatively be a metal oxide, such as tin dioxide (SnO₂), titanium dioxide (TiO₂), or lithium titanate (e.g., Li₂TiO₃ or Li₄Ti₅O₁₂), or a composite of carbon and a metal oxide. In other embodiments, the anode may be composed partially or completely of a suitable metal or metal alloy (or intermetallic), such as tin, tin-copper alloy, tin-cobalt alloy, or tin-cobalt-carbon intermetallic. In some embodiments, any one or more of the above types of negative electrodes may be excluded from the battery.

In the event of the battery being an alkali-ion or other ion-type battery, the negative (anode) electrode of the battery may be a carbon-based composition in which alkali or other ions can be stored (e.g., intercalated or embedded), such as elemental carbon, or more particularly graphite (e.g., natural or artificial graphite), petroleum coke, carbon fiber (e.g., mesocarbon fibers), or carbon (e.g., mesocarbon) microbeads. The anode may be at least 70 80, 90, or 95 wt % elemental carbon. The negative electrode may alternatively be a metal oxide, such as tin dioxide (SnO₂) or titanium dioxide (TiO₂), or a composite of carbon and a metal oxide.

The positive and negative electrode compositions may be admixed with an adhesive (e.g., PVDF. PTFE, and co-polymers thereof) in order to be properly molded as electrodes. Typically, positive and negative current collecting substrates (e.g., Cu or Al foil) are also included. The solid or gel electrolyte composition is typically incorporated in the form of a film, typically having a thickness of at least 0.5, 1, 10, or 20 microns and up to or less than 50, 100, or 200 microns. The film of solid or gel electrolyte is typically made to be in contact with at least one (more typically both) of the electrodes. The assembly and manufacture of lithium-based batteries are well known in the art.

In other embodiments, the battery is a sodium metal or sodium-ion battery containing an electrolyte in which any of the above described HNP compositions is incorporated as an additive. The electrolyte is in contact with the anode (negative electrode) and cathode (positive electrode) of the sodium-based battery. Alternatively, the electrolyte can be incorporated into a cathode of the sodium-based battery (typically admixed with a binder material), with the anode and cathode in contact with any of the above-described electrolytes. Sodium metal batteries are well known in the art, such as described in, for example, H. Sun et al., Nature Communications, 10, 3302, 2019, the contents of which are herein incorporated by reference. Sodium-ion batteries are also well known in the art, such as described in, for example, U.S. Application Publication No. 2012/0021273, and B. L. Ellis, et al., Current Opinion in Solid State and Materials Science, 16, 168-177, 2012, the contents of which are herein incorporated by reference in their entirety. In embodiments where the electrolyte is in contact with an anode and cathode of the sodium-based battery but not incorporated into the cathode, the sodium-based battery may employ, for example, a sodium inorganic material as the active material in the cathode. Some examples of sodium inorganic materials include, for example, NaFeO₂, NaMnO₂, NaNiO₂, and NaCoO₂. Other cathode materials for sodium-based batteries include transition metal chalcogenides, such as described in U.S. Pat. No. 8,906,542, and sodium-lithium-nickel-manganese oxide materials, such as described in U.S. Pat. No. 8,835,041, the contents of which are herein incorporated by reference in their entirety.

In another embodiment, the battery is a magnesium or calcium metal battery or Mg-ion or Ca-ion battery containing an electrolyte in which any of the above described HNP compositions is incorporated as an additive. In the Mg-based or Ca-based battery, a Mg-containing or Ca-containing electrolyte containing the HNP composition as an additive is in contact with the anode (negative electrode) and cathode (positive electrode) of the Mg-based or Ca-based battery. Alternatively, a Mg-containing or Ca-containing electrolyte containing the HNP composition as an additive can be incorporated into a cathode of the Mg-based or Ca-based battery, and the anode and cathode in contact with the electrolyte.

Magnesium metal batteries are well known in the art, such as described in, for example, S.-B. Son et al., Nature Chemistry, 10, 532-539, 2018, the contents of which are herein incorporated by reference. Magnesium-ion batteries are also well known in the art, such as described in, for example, M. M. Huic, et al., Coordination Chemistry Reviews, vol. 287, pp. 15-27, March 2015; S. Tepavcevic, et al., ACS Nano, DOI: 10.1021/acsnano.5b02450, Jul. 14, 2015; Beilstein J. Nanotechnol., 5, 1291-1311, 2014; and U.S. Pat. No. 9,882,245, the contents of which are herein incorporated by reference in their entirety. The magnesium battery may contain any of the components typically found in a magnesium battery, including cathode (positive) and anode (negative) electrodes, current collecting plates, and a battery shell, such as described in, for example, U.S. Pat. Nos. 8,361,661, 8,722,242, 9,012,072, and 9,752,245, the contents of which are incorporated herein by reference in their entirety. The positive electrode can include, as an active material, for example, a transition metal oxide or transition metal sulfide material, such as the composition MₓMo₆T₈, wherein M is at least one metal selected from alkaline earth and transition metals, T is selected from at least one of sulfur, selenium, and tellurium, and x is a value of 0 to 2. The negative electrode is generally a magnesium-containing electrode, which may include magnesium in elemental or divalent form. In elemental form, the magnesium may be either in the absence of other metals (i.e., substantially or completely pure magnesium, except for a possible trace of other metals, e.g., up to 1, 0.5, or 0.1 wt %) or in the form of a magnesium alloy, e.g., AZ31, AZ61, AZ63, AZ80, AZ81, ZK51, ZK60, ZC63, or the like. In some embodiments, the negative electrode can be or include a magnesium intercalation material, which may, before operation, not yet include magnesium intercalated therein. Some examples of magnesium intercalation materials include any of the materials described above for the positive electrode, anatase or rutile TiO₂, FeS₂, TiS₂, or MoS₂. Ca-ion batteries are also known in the art, such as described in Md. Adil et al., ACS Appl. Mater. Interfaces, 12(10), 11489-11503, 2020, the contents of which are herein incorporated by reference.

Zinc metal batteries are known in the art, such as described in, for example, F. Wang et al., Nature Materials, 17, 543-549, 2018, the contents of which are herein incorporated by reference. Zinc-ion batteries are also well known in the art, such as described, for example, in U.S. Pat. No. 8,663,844 and B. Lee et al., Scientific Reports, 4, article no. 6066 (2014), the contents of which are herein incorporated by reference. The cathode can include, for example, a composition based on manganese dioxide, and the anode may be zinc or zinc alloy. An Zn-containing electrolyte containing the HNP composition as an additive can be incorporated into the zinc metal or zinc-ion battery.

The battery may also be an aluminum metal or aluminum-ion battery. Aluminum-ion batteries are well known in the art, such as described, for example, in U.S. Pat. No. 6,589,692 and WO 2013/049097, the contents of which are herein incorporated in their entirety. The cathode can include, for example, a graphitic, manganese oxide (e.g., Mn₂O₄), or vanadium oxide material cathode, and the anode may be aluminum or aluminum alloy. An Al-containing electrolyte containing the HNP composition as an additive can be incorporated into the aluminum metal or aluminum-ion battery. The battery may analogously be a copper-based or silver-based battery, in which case a Cu-containing or Ag-containing electrolyte containing the HNP composition as an additive can be incorporated as a solid electrolyte in the battery.

Examples have been set forth below for the purpose of illustration and to describe certain specific embodiments of the invention. However, the scope of this invention is not to be in any way limited by the examples set forth herein.

### Examples

### Overview

In one aspect, a new single ion conducting hairy nanoparticle electrolyte is provided. In another aspect, the new single ion conducting hairy nanoparticle electrolyte is used as an additive for solid polymer electrolytes. Silica nanoparticles with grafted single Li-ion conductive polymer were synthesized using “grafting from” methodology as well known in the art. The hairy nanoparticles (HNPs) contain a nanosized ceramic core whose high mechanical properties can inhibit dendrite formation, while the mono-ion conducting polymer grown from the core may enhance Li-ion transport due to immobility of the anion. In the present study, small amounts of HNPs were added to polyethylene oxide (PEO)-lithium bis(trifluoromethylsulfonyl)imide (LiTFSI) solid electrolyte membrane. The cycling stability performance of the resulting hairy composites (Hairy PC) electrolytes were tested and compared to that of pure PEO-LiTFSI electrolyte and composites of PEO-LiTFSI containing a polyanion or a single ion conducting polymerized ionic liquid (PolyIL PC). The added PolyIL was selected to be a chemically identical to the individual polymer grafts grown from the nanoparticles. The Hairy PC solid electrolyte was shown to outperform PolyIL PC and PEO-LiTFSI and promote a dendrite-free Li deposition.

### Syntheses

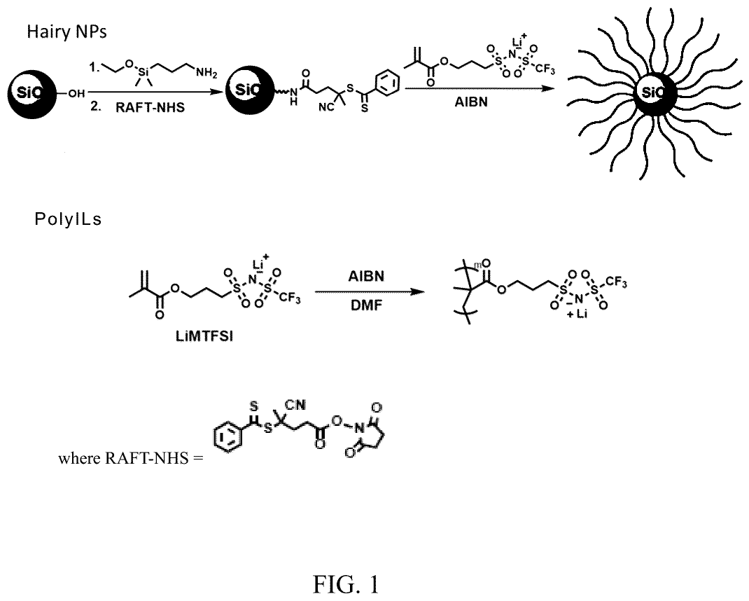

Synthesis of silica NPs functionalized with RAFT-initiator (CTA-silica NPs): CTA-silica NPs were synthesized as generally shown in the scheme in FIG. 1, which is a modified process of a literature procedure (Macromolecules 2006, 39, 3175-3183). Amine-terminated silica NPs were synthesized from colloidal silica NPs (particle size 10-15 nm). The colloidal silica NPs solution (20 mL), 3-(Ethoxydimethylsilyl) propylamine (1.1 mL) and dry THF (50 mL) were placed in a 100 mL round bottom flask and purged with nitrogen for 20 minutes. The reaction mixture was refluxed overnight under nitrogen. The reaction was stopped by cooling it to room temperature and precipitated into hexanes (500 mL). The amine functionalized silica NPs were recovered by centrifugation and further purified by redissolving in THF (20 mL) followed by precipitating in 200 mL of hexane. In the second step, the THF (25 mL) solution of gel 5 g of the amine-terminated silica NPs was added dropwise into the THF (50 mL) solution of 4-Cyano-4-(phenylcarbonothioylthio)pentanoic acid N-succinimidyl ester (1 g). The reaction mixture was purged with nitrogen for 30 minutes and stirred at room temperature for overnight. The CTA-silica NPs were collected after three-times precipitation and centrifugation (4000 rpm, 30 min) over hexane, diethylether, and cyclohexane to remove unreacted the starting materials, and then stored it at below −20° C. freezer before use.

Synthesis of poly(trifluoromethane)sulfonimide lithium methacrylate (polyMTFSILi) or poly (TFSI-Li) hairy NPs: The poly (TFSI-Li) hairy NPs were synthesized as generally shown in the scheme in FIG. 1 (top). The RAFT initiator CTA-silica NPs (600 mg), (trifluoromethane)sulfonimide lithium methacrylate (LiMTFSI) (12.2 g), AIBN (13.2 mg), DMF (20 mL), and methanol (5 mL) were transferred to a Schlenk flask and dissolved by sonication for 10 min at room temperature. The mixture was stirred and purged with nitrogen for 30 min at room temperature to remove oxygen. The sealed flask was placed in a preset oil bath at 70° C. to conduct RAFT polymerization for 23 hours, and the polymerization was stopped and quenched by cooling the reaction flask under ice water. The reaction mixture was purified by dialysis in methanol to remove unreacted monomer. Free poly (TFSI-Li) polymer chains were separated from the product by centrifugation with co-solvent system of IPA/ethanol/THF/hexane. The poly (TFSI-Li) hairy NPs were collected from the bottom part of the centrifuged tube. The hairy NPs were further purified by washing with a co-solvent of IPA/hexane and collected from bottom part after centrifugation. The hairy NPs were dried under vacuum at room temperature.

Synthesis of bulk poly (TFSI-Li) (i.e., “polyILs” or polyanion): The polyILs were synthesized as generally shown in the scheme in FIG. 1 (bottom). The (trifluoromethane)sulfonimide lithium methacrylate (MTFSILi) (9 g), AIBN (52.9 mg), and DMF (degassed, 42.3 mL) were transferred to a dry Schlenk flask. The mixture was stirred at room temperature to dissolve MTFSILi monomer and purged with nitrogen for at least 30 min to remove oxygen. The sealed flask was placed in an oil bath at 65° C. to initiate free radical polymerization for overnight. The polymerization was quenched by cooling the reaction flask. The reaction mixture was purified by dialysis in methanol and then in water for two days to remove unreacted monomer. The purified bulk poly (TFSI-Li) was dried under high vacuum.

Thermogravimetric analysis (TGA) was used to estimate the silica weight fraction, grafting density and Mw of the polymer in Hairy NPs. The TGA curves were measured using commercial instruments. The experiments were run at a rate of 10° C./min, under air. Normalized curves for pristine Nissan NP, NP with grafted RAFT initiator, and Hairy NP were obtained. The calculations were performed based on the weight loss between 260° C. and 800° C. using an NP diameter of 10 nm, silica density of 2.4 g/cm³, and Mws of the RAFT and monomer of 393.6 g/mol and 345.2 g/mol, respectively. The weight of silica nanoparticles in Hairy NP was 26 wt %. A grafting density of RAFT initiator was found to be 0.5 chains per nm², while, assuming that all initiators begin polymerization, the grafted polymer had a Mw of 12.3 kDa. By exposing the polymer to HF solution, it was also possible to separate it from the nanoparticles. However, due to the difficulty of estimating the Mw of delaminated polymer with GPC due to its ionic nature, TGA analysis was used.

Preparation of Hairy NP polymer composites (PCs): 0.75 g of PEO (Mw 400K), 0.25 g of Li-TFSI, and the hairy NP, as synthesized (10 mg, 50 mg. 100 mg for 1%, 4.8%, and 9.1% of single Li-ion conducting hairy NP, respectively) were added into a 100 mL-sized round flask containing 50 mL of pre-mixed solvent of DI water/acetonitrile/methanol (volume ratio 6:4:1 v/v %). The flask was stirred using a magnetic bar until fully dissolved. The solution was poured into a Teflon dish placed on a hot plate and dried at 85° C. for at least 6 hours, and then the composite was moved to a vacuum oven set at 60° C. for 1 day to remove the residual solvent. The composite samples are referred to as follows: Hairy_1 (with 1% of hairy NP), Hairy_5 (with 4.8% of hairy NP) and Hairy_10 (with 9.1% of hairy NP).

Preparation of PolyIL PCs: 0.75 g of PEO (Mw 400K), 0.25 g of Li-TFSI, and PolyILs, as synthesized (7.4 mg, 37 mg, 74 mg for 0.7%, 3.6%, and 6.9% of single Li-ion conducting PolyIL, respectively) were added into an 100 mL-size round flask containing 50 mL of acetonitrile. In order to get the same percent weight of PolyILs in PolyIL PCs as in Hairy NP PCs, the 26 wt % representing silica nanoparticles (found from TGA) was subtracted from the total weight of the polymer added to the composite. The flask was stirred using a magnetic bar until fully dissolved. The solution was poured into a Teflon dish placed on a hot plate and dried at 85° C. for at least 6 hours under nitrogen, and then the composite was moved to a vacuum oven set at 110° C. for 1 day to remove the residual solvent. The composite samples are referred to as follows: PolyIL_1 (with 0.7% of PolyIL), PolyIL_5 (with 3.6% of PolyIL), and PolyIL_10 (with 6.9% of PolyIL). All samples were stored in the glove box until further use.

For film preparation, all the samples were hot pressed between Kapton films at ˜100° C. for less than 30 second, and the membrane prepared was vacuum oven dried at 110° C. for 3 days to remove any water absorption during the pressing and then slowly cooled down to room temperature. In order to achieve this, the oven was switched off and left to cool naturally in the vacuum (the cooling rate was approximately 0.5° C./minute). During the oven drying procedure, Kapton films were not removed in order to keep polymer distribution even.

### Testing and Measurements

Broadband Dielectric Spectroscopy (BDS). The dielectric spectra were collected in the frequency range of 10⁻¹ to 10⁷ Hz using a control system that includes an impedance analyzer and a temperature control unit. The samples were measured using a parallel-plate dielectric cell. The separation between the electrodes was maintained at 0.21 mm, while the effective diameter of the electrodes was 10.2 mm, yielding a geometrical capacitance of 2.1 pF. Prior to the experiments, the dielectric cell was placed inside a cryostat with a nitrogen atmosphere and equilibrated at 403 K for at least 1 hour. Before acquiring each dielectric spectrum, the sample was equilibrated for at least 15 min to achieve a thermal stabilization within 0.2 K after each temperature step. The measurements were performed from high to low temperatures and back to high temperatures to check the reproducibility of the results. The obtained data indicated that the samples did not degrade upon heating, and they contained no residual solvents at low temperatures.

Rheology Measurements. The shear measurements were performed on a commercial rheometer. The temperature control had an accuracy of ±0.1 K. Small amplitude oscillatory shear (SAOS) with a strain amplitude γ=1% was performed at frequencies between 100 and 0.01 Hz on a pair of parallel plates with a diameter of 8 mm. For each sample, the corresponding SAOS spectrum was measured in terms of real (storage) G′ and imaginary (loss) G″ components of the complex shear modulus at a temperature of 60° C. The storage moduli of different composites were compared by considering their values at 10 Hz, a frequency at which this quantity largely reflects the amplitude of the rubbery plateau which is fully emerging at higher frequencies.

Differential Scanning calorimetry. The glass-transition temperature, Tg, and melting temperature were determined using temperature-modulated differential scanning calorimetry (TMDSC). Samples of about 10 mg were sealed in aluminum Tzero pans and annealed at 433 K for 20 min. Then they were measured at an average 3 K/min rate with the temperature modulation amplitude and period of ±0.5 K and 60 s, respectively. T_{g} was defined as the inflexion point temperature in the reversible heat flow upon heating. The melting point was defined from the peak position of exothermic peak.

Electrochemical testing. Cycling stability of the electrolytes towards Li metal dendrite formation was evaluated in Li/Li symmetric cells (CR2032 coin cell format). Coin cells were assembled inside an Ar filled glovebox with moisture and oxygen levels below 0.5 ppm. Lithium ribbon (0.75 cm thickness) was first scratched with a plastic brush to remove surface passivation layer and cut into ⅜ inch discs. Symmetric Li cells were assembled by sandwiching solid polymer membranes (diameters of 6 and 8 mm) between two Li discs. After conditioning the cells for 24 h at 60° C. in a temperature controlled chamber, the cells were galvanostatically cycled at 60° C. using a potentiostat at various current densities. The strip/plate half cycles were set to 1 h or 5 h long. A 10-20 min long rest was applied between each strip/plate half cycle.

Transport number measurements and estimations. Li⁺ transference number was obtained using the Bruce and Vincent method. Li symmetric cells with the electrolyte membranes of interest were prepared the same way as those used for electrochemical testing. The cells were equilibrated at 70° C. for 48 hours before the impedance was measured at open circuit voltage (OCV) using an impedance spectrometer. Then chronoamperometric measurement was carried out at an applied potential (ΔV) of 10 mV for 10 hours. At the end of 10 hours of polarization time, the impedance was measured again with the applied 10 mV potential. The cation transference number (t₊) was then calculated using Equation 1 (below). The initial current (Iₒ) is calculated using Ohm's law ΔV=I_{O}·R_{Ω}, where ΔV=10 mV is the applied bias, and R_{Ω} is the total cell resistance obtained from the impedance spectrum prior to applying DC bias. As the concentration gradient established in the cell, the steady state current, I_{SS}, was read from the chronoamperometry at the end of 10 hours of equilibration. R_{O} was the initial interfacial resistance and R_{SS} was the steady state interfacial resistance.

$${t}_{+} = \frac{{I}_{s s}}{{I}_{0}} ( \frac{ΔV - {I}_{0} {R}_{0}}{ΔV - {I}_{s s} {R}_{s s}} )$$

Transmission Electron Microscopy. Thin sections with thickness of approximately 100 nm were obtained by microtoming a piece of bulk film at −90° C., using a cryomicrotome. The thin sections were placed onto a lacey carbon supported copper grid. The samples were not stained. TEM experiments were performed on an aberration-corrected TEM/STEM microscope using 300 keV acceleration voltage and equipped with a cryo-stage. TEM images of the thin microtomed sections were collected at −180° C.

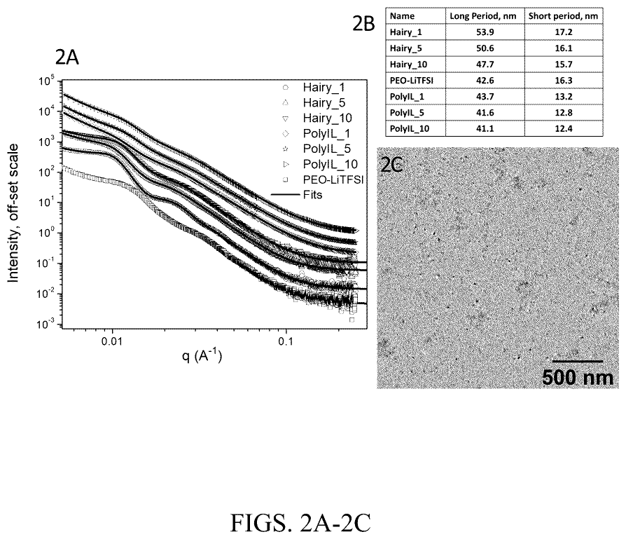

Small Angle X-ray Scattering. X-ray scattering measurements were performed on the thin films using a SAXS/wide-angle X-ray scattering platform equipped with a Ga-anode source (λ≈1.34 Å) and a moving detector in-vacuum using a detector for 2D data collection. Hot presses were used to prepare films with thicknesses ranging between 0.2 and 0.7 mm for SAXS measurements. The obtained 2D scattering data were reduced and azimuthally integrated into 1D plots of scattering intensities, I(q), as a function of momentum transfer, q (q=(4π sin θ)/λ, where θ is half of the scattering angle). The results are presented in FIG. 2A.

### Results and Discussion

The poly (TFSI-Li) hairy NPs with the grafting density of 0.5 chains per nm² and Mw=12.3 kDa were synthesized using RAFT initiated grafting from polymerization using silica nanoparticles with silica core of 10 nm. The bulk poly (TFSI-Li) polymerized ionic liquid (PolyIL) was synthesized using radical polymerization. The main reaction steps for synthesis of hairy NP and PolyIL are shown in FIG. 1. Based on TGA data, the silica weight fraction was estimated at 26 wt % in hairy NPs. The as-prepared solvent free hairy NP and PolyIL have high glass transition temperatures of 201° C. and 190° C., respectively, that were measured using DSC. The composites were made by the addition of either hairy NPs or polymerized ionic liquid to the PEO-LiTFSI matrix, wherein the resulting composites are referred to as Hairy PCs and PolyIL PCs, respectively. In the case of Hairy NP PCs, the final composites contained 1 wt % (Hairy_1), 4.8 wt % (Hairy_5), and 9.1 wt % (Hairy_10) of hairy NPs. While preparing the PolyIL PCs, the polymer content was reduced by an amount of SiO₂ (26 wt %) resulting in PolyIL_1 with 0.7 wt %, PolyIL_5 with 3.6 wt %, and PolyIL_10 with 6.9 wt % of PolyIL.

The morphology of the composites was examined with SAXS, where the scattering spectra and their corresponding fitting are shown in FIG. 2A. The PEO crystallizes into a lamellar structure and PEO/LiTFSI blends maintain the semicrystalline properties of PEO. A lamellar structure is manifested in a broad first-order peak followed by second-order reflections.

The two-phase lamellar layer model was used to characterize semicrystalline PEO phase morphology and to gain insight into changes in its structural organization with addition of hairy NP and PolyIL. The characteristic lamellar dimensions are summarized in the table in FIG. 2B.

The dispersion state of hairy NPs in Hairy PC was evaluated from SAXS and TEM. The scattering profiles show no evidence of phase separation or hairy NP aggregation. The TEM image (FIG. 2C) of Hairy_10 composite confirms that hairy NPs are well dispersed in the PEO-LiTFSI matrix.

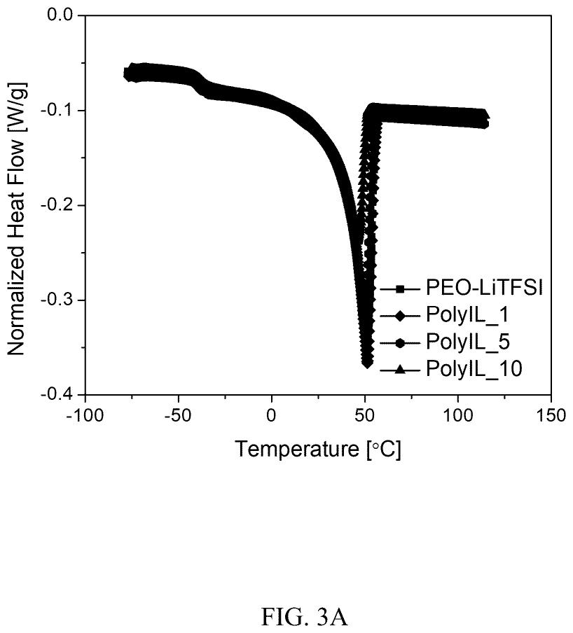

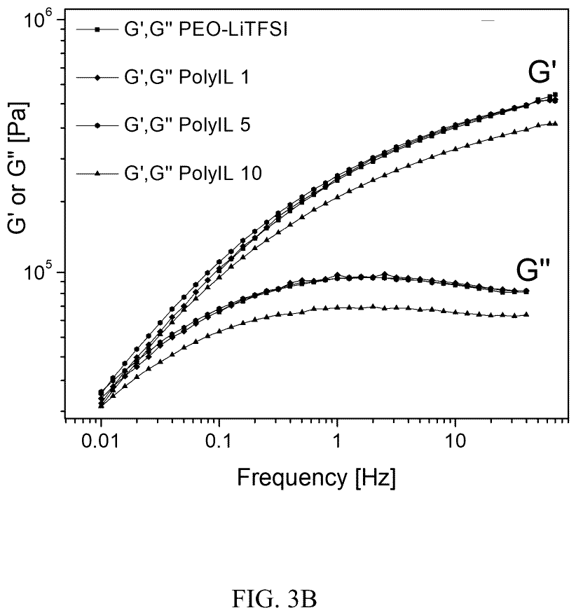

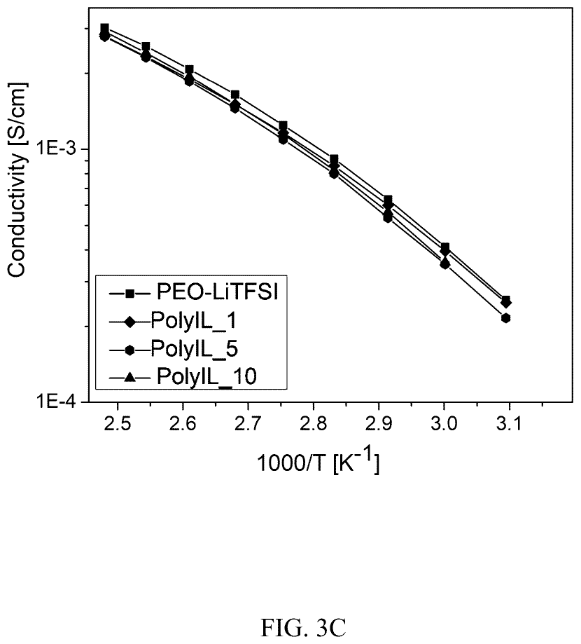

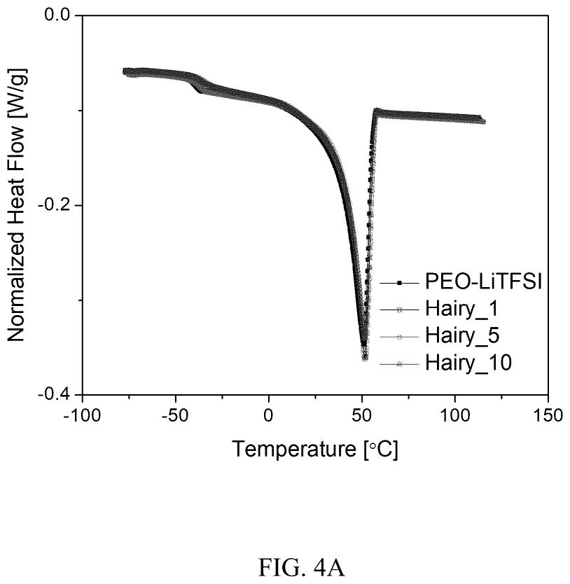

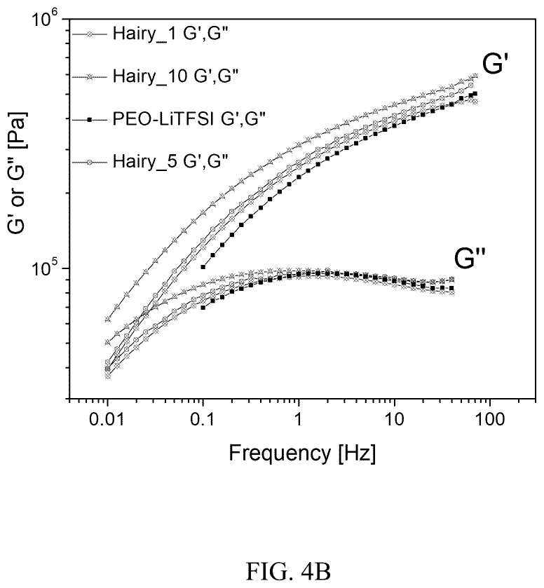

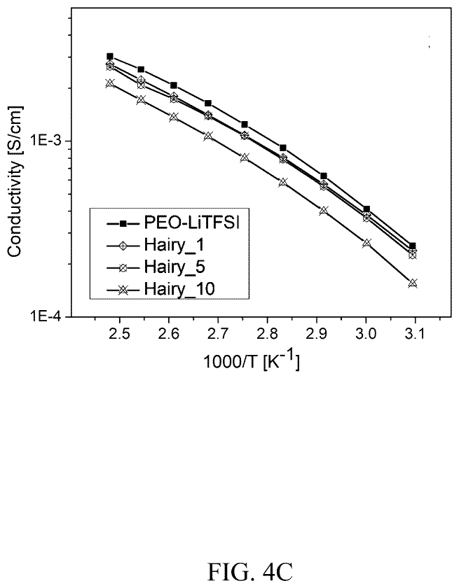

DSC was used to assess the glass transition and melting temperatures of composites. The corresponding thermograms are presented in FIG. 3A for the PolyIL PCs and in FIG. 4A for Hairy PCs. The T_{g}s and the melting temperatures obtained from the heating cycles are summarized in Table 1. For PolyIL PCs and Hairy PCs, the increase in concentration of additives led to an increase in T_{g}. Even the smallest concentration of additives in both PCs produced a higher T_{g} values compared to PEO-LiTFSI.

The melting temperatures of PolyIL PCs decrease with increasing concentration of PolyIL, while it remains unchanged in Hairy PCs. The temperature values for PolyIL_1 and all Hairy PC are similar to that of PEO-LiTFSI, while PolyIL_10 displays a melting temperature of 5° C. lower compared to the PEO-LiTFSI. Observations of lower melting temperatures in PolyIL PCs are likely caused by the disturbed PEO crystallization process. Indeed, the decrease in area of melting peak, as shown in FIG. 3A, is a clear indicator of the inhibition of crystallization that occurs with increasing concentrations of PolyILs. In contrast, the melting peak area for Hairy PCs (FIG. 4A) either very slightly increases or remains unchanged compared to that of PEO-LiTFSI. This suggests that the crystallization of the PEO is improved in Hairy_1 and unaffected in the case of Hairy_5 and Hairy_10. These trends are also in line with the behavior of lamellar spacing obtained from SAXS.

TABLE 1
Summary of all experimentally measured parameters for composites, such as glass transition
temperature (T_{g}), melting temperature (T_{melting}), aging (ΔT_{g}), transport number,
where the conductivity (σ) and shear moduli (G′) are reported at 60° C.

| | | | T | σ_{dc} (60° C.), | G′ (60° C.), | Transport |
|---|---|---|---|---|---|---|
| | T_{g}, ° C. | ΔT_{g}, ° C. | melting, ° C. | mS/cm | MPa | Number |
| PEO- LiTFSI | −36.7 | 1.6 | 51.1 | 0.41 ± 0.04 | 0.37 ± 0.04 | 0.16 ± 0.06 |
| PolyIL_1 | −35.4 | 1.1 | 51.4 | 0.40 ± 0.04 | 0.38 ± 0.04 | 0.14 ± 0.06 |
| PolyIL_5 | −34 | 1.1 | 49.6 | 0.35 ± 0.03 | 0.38 ± 0.04 | 0.17 ± 0.09 |
| PolyIL_10 | −33.5 | 1.5 | 45.8 | 0.36 ± 0.04 | 0.31 ± 0.03 | 0.25 ± 0.11 |
| Hairy_1 | −35 | 1.2 | 51.6 | 0.38 ± 0.04 | 0.39 ± 0.04 | 0.22 ± 0.03 |
| Hairy_5 | −34.8 | 0.8 | 51.7 | 0.36 ± 0.04 | 0.41 ± 0.04 | 0.25 ± 0.06 |
| Hairy_10 | −32.2 | 0.6 | 51.5 | 0.26 ± 0.03 | 0.46 ± 0.06 | 0.15 ± 0.04 |

The mechanical properties of the PEO-LiTFSI precursor material and its corresponding PolyILs and hairy nanoparticle-based composites were evaluated from shear rheology. The viscoelastic data measured at 60° C. for PolyIL PCs and Hairy PCs are presented in FIG. 3B and FIG. 4B, respectively, in the form of storage (G′) and loss (G″) shear moduli. The storage moduli collected at 10 Hz and presented in Table 1 is indicative of the variation in the global stiffness among different polymeric materials. From these data, one can recognize that in case of addition of PolyIL a pronounced reduction in mechanical strength is achieved in PolyIL_10 while the PolyIL_1 and PolyIL_5 composites do not substantially differ from the PEO-LiTFSI matrix. Contrary to the behavior of PolyIL, the addition of hairy NP leads to a consistent increase in the mechanical strength. The strongest increase among all composites is observed for Hairy_10 composite, which exhibits about 20% larger stiffness with respect to the incipient PEO-LiTFSI material

The effect observed in the PolyIL_10 composite may be associated with the reduction in the melting temperature of this composite measured with DSC, which indicates that the crystalline phase of PEO does not contribute to mechanical properties in this composite. Contrary to the behavior of PolyIL, the addition of hairy NPs leads to a consistent increase in the mechanical strength with increasing concentration of NPs. The strongest increase among all composites is observed in the Hairy_10 composite, which exhibits about 20% higher stiffness compared to the incipient PEO-LiTFSI material.

The conductivity of a composite electrolyte was evaluated by BDS spectroscopy. The conductivity measurements were conducted from 50-130° C. The conductivity spectra indicate a typical behavior for ionic materials with a frequency-independent dc conductivity plateau, σ_{dc}, followed by a large drop at lower frequencies due to electrode polarization effects. The conductivity values selected from the conductivity plateau and plotted vs. temperature for PolyIL PCs and Hairy PCs are presented in FIG. 3C and FIG. 4C, respectively. A conductivity spectrum for PEO-LiTFSI has been added to FIGS. 3A and 4A to better highlight the differences. In the studied temperature interval, the de conductivity for all materials follows the Vogel-Fulcher-Tamman (VFT) behavior, which is characteristic of the behavior of the polymer electrolytes above their glass transition temperature. The latter finding is consistent with the results of Tg measurements using the DSC method.

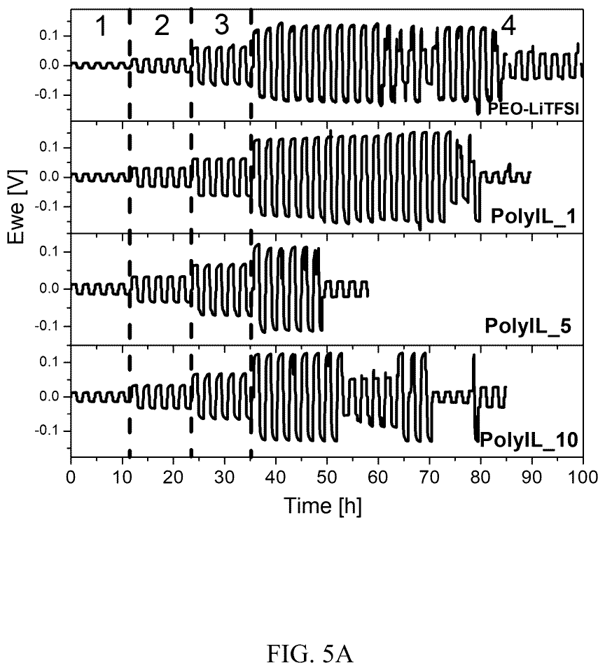

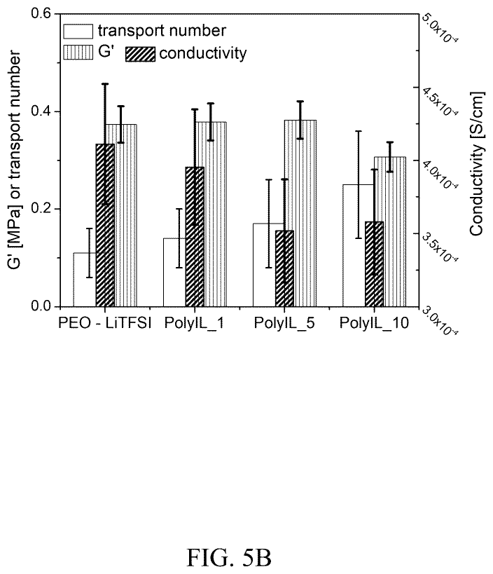

The long-term electrochemical stability of composite solid electrolytes against the Li metal was evaluated by using a Li symmetric cell. FIG. 5A displays voltage profiles of the cells containing PolyIL PCs and PEO-LiTFSI, cycled at the current densities of 0.035, 0.088 and 0.175 mA·cm⁻² for 5 cycles at each current density, followed by a longer cycling at 0.35 mA·cm⁻². It can be observed that the cycle life did not improve by incorporating PolyIL into PEO-LiTFSI.

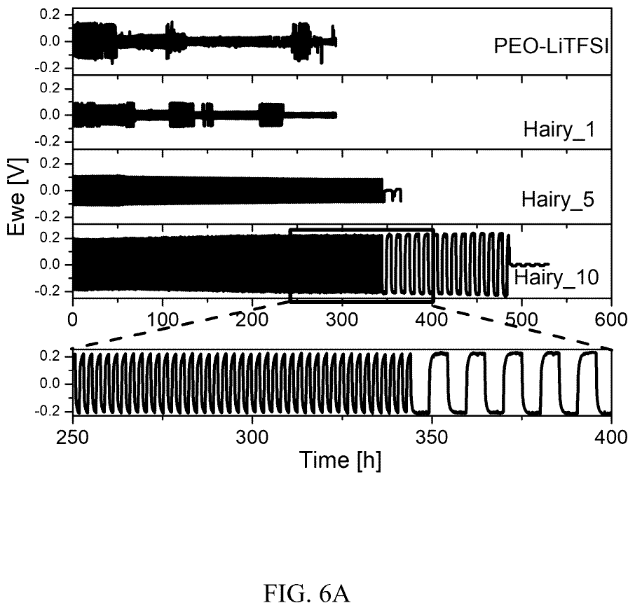

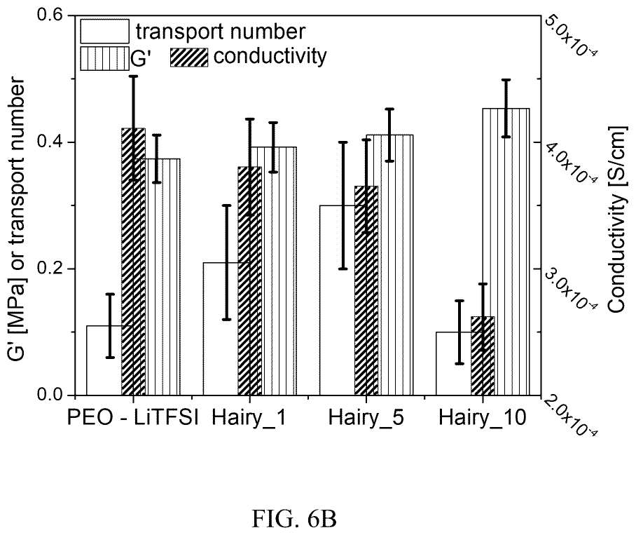

The cycling profiles of the Hairy PCs and PEO-LiTFSI at 0.2 mA·cm⁻² are presented in FIG. 6A. The cycling performance of PEO-LiTFSI was enhanced with the inclusion of hairy NPs. The cells with Hairy_5 and Hairy_10 composites showed excellent long-term stability at 0.20 mA·cm⁻² for 340 h of cycling at a capacity of 0.20 mAh·cm⁻². When the capacity of the cycling was extended to 1 mAh·cm⁻² (current density 0.20 mAh·cm⁻² for 5 hours), Hairy_5 PC failed quickly, while Hairy_10 PC maintained a stable performance for an additional ˜150 h. Clearly, from the electrochemical stability standpoint, the Hairy_5 and Hairy_10 PCs composites outperformed PEO-LiTFSI and PolyIL PCs.

To identify the possible mechanism leading to the improvement in cycling stability in Hairy PCs, the impact of additives was analyzed on the bulk properties and interfacial resistance. The bulk properties at 60° C. (the temperature at which the electrochemical testing was conducted) for all composites are summarized in Table 1 and as a bar chart in FIG. 5B (PolyIL PCs) and 6B (Hairy PCs). As evident from FIG. 5B, the mechanical moduli of PolyIL PCs are either not different from those of PEO-LiTFSI or decreased as in PolyIL_10 composite. Analysis of transport number using the Bruce-Vincent method (Eq.1) demonstrates a progressive rise in transport number of PolyIL PCs as the concentration of PolyIL increased. The conductivity in PolyIL PCs is reduced compared with PEO-LiTFSI, which also correlates with the behavior of Tg for these materials.

By comparison, the addition of hairy NPs resulted in a steady increase in mechanical strength (as shown in the bar chart in FIG. 6B), while the transport number of Hairy PCs did not show a unified trend. It initially increased with increasing concentrations of hairy NPs, but then decreased in Hairy_10 to the value of PEO-LiTFSI. Table 1 shows that the decrease in conductivity of Hairy PCs with concentration is more pronounced compared to PolyIL PCs. This result is consistent with the stronger increase in T_{g} values observed in the Hairy PCs. This observation is significant because the mobility of PEO segments, which is crucial for ion transport in PEO, is determined by T_{g}. An increase in T_{g} and, as a result, a decrease in PEO segmental mobility, can also impact the solvation behavior of PEO towards Li-ions. Specifically, reduced mobility of PEO can result in less effective interactions between PEO and Li-ions, particularly those present on the polymer chains attached to the nanoparticles where the motion of polymer chains is more restricted due to grafting. The reduced chain flexibility of PEO segments may explain a reduction in the Li transport number, as observed in the Hairy_10 sample.

As demonstrated from DSC, BDS, and rheology studies, the Hairy PCs show a consistent trend in T_{g}, conductivity, and mechanical stiffness with concentrations while the trends in these properties for PolyIL PCs are less well-established. This may suggest a more structurally and dynamically heterogeneous PolyIL distribution within PEO-LiTFSI as compared to the composites with added hairy NPs. To gain deeper insights into the possible presence of dynamic heterogencities in the bulk PCs, the differences in T_{g} were monitored as extracted upon heating and cooling from DSC (using the same heating/cooling rate). Table 1 summarizes the corresponding results for ΔTg. With the increase in hairy NP concentration, there is a clear decrease in T_{g}, ranging from ΔTg=1.6° C. for PEO-LiTFSI to 0.6° C. in Hairy_10. Regarding PolyIL PCs, no consistent variation in ΔTg was found, although the corresponding values are close to the ΔTg value of PEO-LiTFSI material. As compared to all other investigated composites, Hairy_10 showed the lowest differences between T_{g} values, which suggests that the addition of NPs leads to more dynamically homogeneous PCs, which likely contributes to the improved cycling stability of the semicrystalline polymer. This is especially true because the plating and stripping cycles were performed at a temperature relatively close to those of crystallization/melting. This advantage of the hairy NPs architecture over non-modified inorganic fillers is particularly relevant, as dispersibility is often a significant issue that can trigger propagation of dendrites.

Upon observing the enhanced cycling performance of Hairy_10 and the lack thereof in the PolyIL PCs, it became evident that improvements in mechanical properties may have a more significant impact on cycling stability than transport number. Improvement in mechanical properties was connected to the increased hairy NP concentration, but this also caused a reduction in chain mobility and solvation of Li-ion with PEO chains, negatively impacting the conductivity and transport number. The conductivity changes are not drastic, with only a maximum of a ˜2-fold decrease observed in Hairy_10 compared to the original conductivity of PEO-LiTFSI. By varying grafting density and molecular weight of the Hairy NPs, there is potential to enhance the solvation of Li-ions and achieve greater benefits in terms of cycling performance and conductivity resulting from the improved transport number.

The Hairy NP has also influenced the performance of the Li/electrolyte interface, which also correlates with improved cycling stability. Hairy NP addition leads to a consistent and noticeable decrease in charge transfer resistance, Rct (obtained from impedance measurement) as concentration increases: 115, 72, and 53 Ohm for Hairy_1, Hairy_5, and Hairy_10, respectively, which correlates with the longer cycle life. The Rct values for PolyIL PCs are similar to those of the PEO-LiTFSI composite, and the performance of these composites, within the experimental uncertainty, also resembles cycling performance comparable to that of PEO-LiTFSI.

The apparent chemical differences between two additives could point to possibly various mechanisms of interface formation and stabilization leading to variations in their performance. As such, when hairy NPs are adsorbed on the electrode, they can chemically passivate the interface, thus leading to its electrochemical stabilization. This could also lead to the increased interfacial resistance in the material. The stabilizing effect of hairy NP on Li-electrode is in line with literature data.

### CONCLUSIONS

The above experiments were directed to the synthesis of hairy NPs with attached poly (TFSI-Li) polymer using RAFT polymerization. These NPs were tested as additives to PEO LiTFSI solid polymer electrolyte. The addition of hairy NPs at concentrations of 4.8% and 9.1% to PEO LiTFSI composites led to a significant improvement in cycling performance as determined by testing in a symmetric Li/Li cell. The improvement in the performance is associated with the changes in bulk and interfacial performance associated with the addition of hairy NPs. The increase in mechanical properties and transport number in the composite with hairy NPs compared to the PEO-LiTFSI sample was shown to promote cycling stability. The rate of interfacial charge transfer was also improved with addition of hairy NPs. For comparison, the addition of PolyIL with the structure equivalent to that of the chains grafted to hairy NP, resulted in improvement in transport number and reduction of mechanical properties, but this combination of properties failed to provide an improved cycling performance. Moreover, the interfacial activity of PolyIL PCs remained similar to that of PEO-LiTFSI.

Notably, the improvement in cycling stability was associated with only a minimal reduction in conductivity with hairy NP addition. Only a ˜1.1 time decrease in conductivity was observed in Hairy_5 composite whereas a ˜2 time change in conductivity was observed in Hairy_10. Despite the reduction in conductivity, Hairy_10 was able to cycle at 0.2 mA/cm² for 490 hours, which couldn't be achieved with PEO TFSI and other tested composites.

The present work has demonstrated a promising new building block material that use can be expanded to other Li-ion conducting solid and liquid electrolytes. Due to the easy cation exchange in the PolyIL material, hairy NPs can be also tested with non-Li conducting electrolytes.

While there have been shown and described what are at present considered the preferred embodiments of the invention, those skilled in the art may make various changes and modifications which remain within the scope of the invention defined by the appended claims.

What is claimed is:

1. A hairy nanoparticle composition comprising:
(i) a nanoparticle core; and
(ii) an ion-conductive polymer chemically attached to the nanoparticle core, wherein the ion-conductive polymer is either polyanionic with mobile cations or polycationic with mobile anions.

2. The composition of claim 1, wherein the ion-conductive polymer is polyanionic with mobile cations.

3. The composition of claim 2, wherein the mobile cations are selected from the group consisting of lithium, sodium, potassium, zinc, magnesium, calcium, and aluminum.

4. The composition of claim 2, wherein anions in the polyanionic polymer contain moieties selected from the group consisting of bis(fluorosulfonyl)imide, carboxylate, sulfonate, and borate.

5. The composition of claim 1, wherein the ion-conductive polymer is polycationic with mobile anions.

6. The composition of claim 5, wherein cations in the polycationic polymer are selected from the group consisting of imidazolium, triazolium, pyrrolidinium, pyridinium, sulfonium, phosphonium, and ammonium.

7. The composition of claim 1, wherein the nanoparticle core has an inorganic composition.

8. The composition of claim 7, wherein the inorganic composition is an oxide composition.

9. The composition of claim 8, wherein the oxide composition is selected from the group consisting of silica, alumina, titania, zirconia, yttria, hafnia, niobia, and combinations thereof.

10. An electrolyte composition comprising hairy nanoparticles incorporated into an ionically conductive electrolyte medium, wherein the hairy nanoparticle composition comprises:
(i) a nanoparticle core; and
(ii) an ion-conductive polymer chemically attached to the nanoparticle core, wherein the ion-conductive polymer is either polyanionic with mobile cations or polycationic with mobile anions.

11. The electrolyte composition of claim 10, wherein the electrolyte medium is a solid or gel electrolyte medium.

12. The electrolyte composition of claim 11, wherein the solid or gel electrolyte is a microporous polymer (organic or inorganic) with or without ionic groups.

13. The electrolyte composition of claim 11, wherein the solid or gel electrolyte medium is selected from the group consisting of polyethylene oxide (PEO), polyvinylidene fluoride (PVDF), polymethyl methacrylate (PMMA), and polyacrylonitrile (PAN).

14. The electrolyte composition of claim 9, wherein the solid or gel electrolyte medium comprises a lithium-containing salt.

15. The electrolyte composition of claim 10, wherein the electrolyte medium is a liquid electrolyte medium.

16. The electrolyte composition of claim 15, wherein the liquid electrolyte medium comprises a polar solvent.

17. The electrolyte composition of claim 10, wherein the ion-conductive polymer is polyanionic with mobile cations.

18. The electrolyte composition of claim 17, wherein anions in the polyanionic polymer are selected from the group consisting of bis(fluorosulfonyl)imide and borate.

19. The electrolyte composition of claim 10, wherein the nanoparticle core has an inorganic composition.

20. The electrolyte composition of claim 19, wherein the inorganic composition is an oxide composition.

21. A metal-ion battery comprising:
(a) an anode;
(b) a cathode; and
(c) an electrolyte composition in contact with said anode and cathode;
wherein said electrolyte composition comprises hairy nanoparticles incorporated into an ionically conductive electrolyte medium, wherein the hairy nanoparticle composition comprises:
(i) a nanoparticle core; and
(ii) an ion-conductive polymer chemically attached to the nanoparticle core, wherein the ion-conductive polymer is either polyanionic with mobile cations or polycationic with mobile anions.

22. The metal-ion battery of claim 21, wherein the electrolyte medium is a solid or gel electrolyte medium.

23. The metal-ion battery of claim 21, wherein the electrolyte medium is a liquid electrolyte medium.

24. The metal-ion battery of claim 21, wherein the ion-conductive polymer is polyanionic with mobile cations.

25. The metal-ion battery of claim 24, wherein anions in the polyanionic polymer are selected from the group consisting of bis(fluorosulfonyl)imide and borate.

26. The metal-ion battery of claim 21, wherein the nanoparticle core has an inorganic composition.

27. The metal-ion battery of claim 26, wherein the inorganic composition is an oxide composition.
